(19) United States
(12) Patent Application Publication
(10) Pub. No.: US 2012/0151209 A1
(43) Pub. Date: Jun. 14, 2012

(54) MULTILEVEL SECURITY SERVER FRAMEWORK

(75) Inventors: ERIK VISNYAK, SAN DIEGO, CA (US); MICHAEL DONOVAN, WASHINGTON, DC (US); BRIAN LOFY, SAN DIEGO, CA (US); JEFF RICE, SAN DIEGO, CA (US)

(73) Assignee: BAE SYSTEMS NATIONAL SECURITY SOLUTIONS INC., SAN DIEGO, CA (US)

(21) Appl. No.: 12/964,209

(22) Filed: Dec. 9, 2010

(51) Int. Cl. H04L 29/06; H04L 9/32

(52) U.S. Cl. 713/166

(57) ABSTRACT

Systems, apparatus and other embodiments associated with a multi-level security (MLS) server framework are presented. An MLS server framework provides a trusted virtual environment to host multiple tenants, categories, classification enclaves and security enclaves. The MLS server framework includes virtual machines, virtual networks, a mandatory access control (MAC), a hypervisor and a virtual trusted platform module (vTPM) management machine. The virtual networks are connected to the virtual machines and the hypervisor is connected to the MAC and the virtual networks. The MAC sets security policies and the hypervisor enforces the security policies and classifies virtual components within a trusted virtual environment formed by the MLS server framework. The vTPM management machine provides attestation of each virtual machine to ensure the MLS server framework is in a secure state.

### BACKGROUND OF THE INVENTION

1. Technical Field

The present invention relates generally to apparatus and systems for a network of computers. More particularly, the apparatus and systems relate to creating a computing environment that is secure against cyber attacks and other attacks. Specifically, the apparatus and systems of the present invention create a multi-level security server framework with virtual machines and virtual networks.

2. Background Information

Today, cross domain information sharing solutions are comprised of a multitude of network, data management, and workstation technologies, mostly providing cross domain messaging (e.g., email and chat) and data transfer services. Technologies exist for tagging and labeling data for use in multiple domains enabling data to be extracted or generated at one domain, labeled and tagged, and then transferred to another domain. High Assurance Platforms (desktop) and thin-client solutions are available for accessing data from multiple domains in separate windows from a single workstation. While these systems may yield effective solutions, they require domain-specific servers, network hardware components and software licenses which require a larger footprint, and impact affordability and maintainability. Therefore, cross domain information sharing computer system is desired.

### BRIEF SUMMARY OF THE INVENTION

The preferred embodiment of the invention comprises a multilevel security (MLS) server framework that provides a trusted virtual environment to host multiple tenants, categories, classification enclaves and security enclaves. The MLS server framework includes virtual machines, virtual local area networks (LANs), a mandatory access control (MAC), a hypervisor and a virtual trusted platform module (vTPM) management machine. The virtual LANs are connected to the virtual machines and the hypervisor is connected to the MAC and the virtual LANs. The MAC sets security policies and the hypervisor enforces the security policies and classifies virtual components within a trusted virtual environment formed by the MLS server framework. The vTPM management machine provides attestation of each virtual machine to ensure the MLS server framework is in a secure state.

In other configurations of the preferred embodiment, the MLS server framework can contain other devices such as an integrity monitor between one of the virtual machines and one of the virtual LANs to conduct deep packet inspection of ingress and egress data-in-transit from each security domain. The MLS server framework can also include a confidentiality service logic between one of the virtual machines and one of the virtual LANs to provide encryption of the data-in-transit to protect the data-in-transit over a shared hardware platform. The MLS server framework can include policy enforcement points (PEPs) to determine, based at least in part on a system status of the MLS server framework, if at least one of the virtual machines is classified to communicate with an approved resource within MLS server framework.

The preferred embodiment of the MLS server framework may further include virtual network switches to provide port authentication and networking to enforce policy and attest the virtual machines to the virtual LANs. A virtual trusted platform module (vTPM) can be used to manage the state of an operating system associated with at least one the virtual machines. The virtual network switches can be layer 3 networking switches that act as policy enforcement points (PEPs) and directly communicates with one or more of the virtual machines. The PEP validates the health status of a virtual machine requesting permission to access one of the virtual LANs.

The preferred embodiment of the MLS server framework can include a virtual vTPM management machine, a basic input/output system (BIOS) and a hardware-based trusted platform module (TPM). The BIOS and vTPM management machine interact with the hardware-based TPM to ensure that no configuration changes have occurred since a trusted build of the MLS server framework was performed. The hardware-based TPM and the BIOS are connected to the hypervisor. Additionally, a random access memory (RAM), a central processing unit (CPU), a hard drive and/or a network interface card may also be connected to the hypervisor.

In another configuration, the MLS server framework of one or more virtual guard components can provide for the transfer of data between two different security enclaves. The vTPM management machine centrally manages the MLS server framework through the one or more virtual guard components. The virtual machines further include a host-based intrusion detection/prevention system that monitors the integrity of a corresponding virtual machine and protects the virtual environment by preventing a connection to a virtual machine that fails a network access control (NAC) policy check by the intrusion detection/prevention system.

### BRIEF DESCRIPTION OF THE DRAWINGS

One or more preferred embodiments that illustrate the best mode(s) are set forth in the drawings and in the following description. The appended claims particularly and distinctly point out and set forth the invention.

The accompanying drawings, which are incorporated in and constitute a part of the specification, illustrate various example methods and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a schematic drawing showing a first embodiment of the MLS server framework.

FIG. 2 is a schematic drawing showing a second preferred embodiment of the MLS server framework.

FIG. 3 (FIGS. 3A-3C) is a detailed schematic drawing of the second embodiment of the MLS server framework.

FIG. 4 (FIGS. 4A-4C) is a detailed schematic drawing of the second and preferred embodiment of the MLS server framework.

Similar numbers refer to similar parts throughout the drawings.

### DETAILED DESCRIPTION OF THE INVENTION

BAE Systems, HP Enterprise Services, Raytheon, Calif. (formerly Computer Associates), and Sun Microsystems have joined together to establish the Cross Domain Solution (CDS) Consortium, and in collaboration with the Trusted Computing Group, are working to develop a series of specifications for cross domain technologies. They have collaborated with the National Security Agency to identify and mitigate certification & accreditation (C&A) risks which will help simplify and expedite the C&A of future cross domain products. The CDS Consortium approach to creating the multi-level security (MLS) server is based on the creation and adoption of components for cross domain technologies suitable for implementation within a virtualized environment. As a result, MLS Server enterprise solutions will be developed and integrated faster by aggregating mature technologies developed to a common model for cross domain information sharing.

One of the key enablers of this MLS server approach is the High Assurance Platform (HAP) Server Technical Reference Model (TRM). The TRM, in conjunction with Trusted Computing Group standards, defines a modular design pattern and series of specifications for vendors and industry that provides a framework into which products for many of the sub-categories listed in the RFI can be integrated.

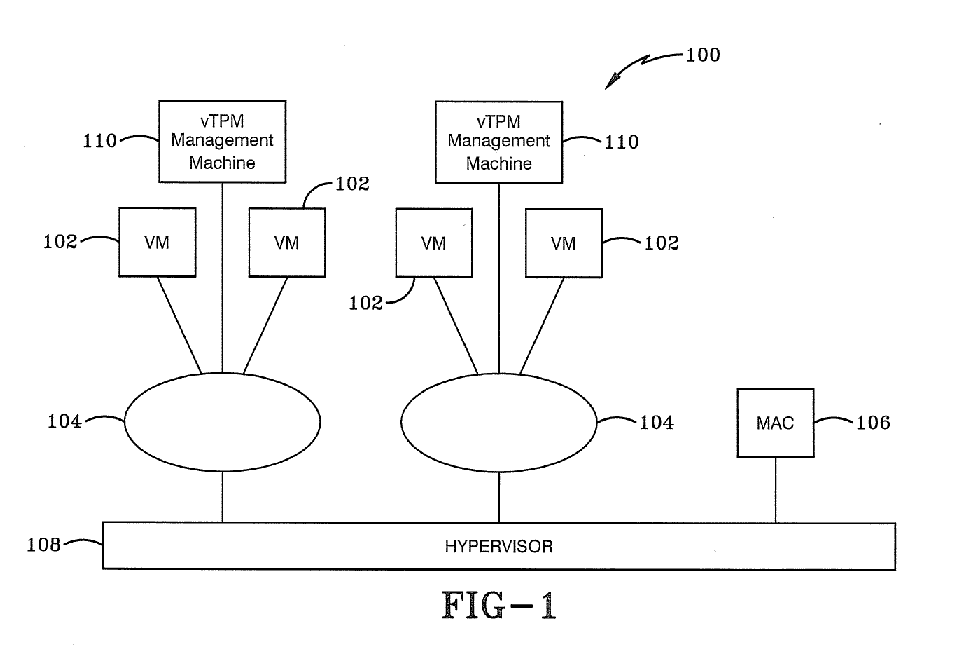

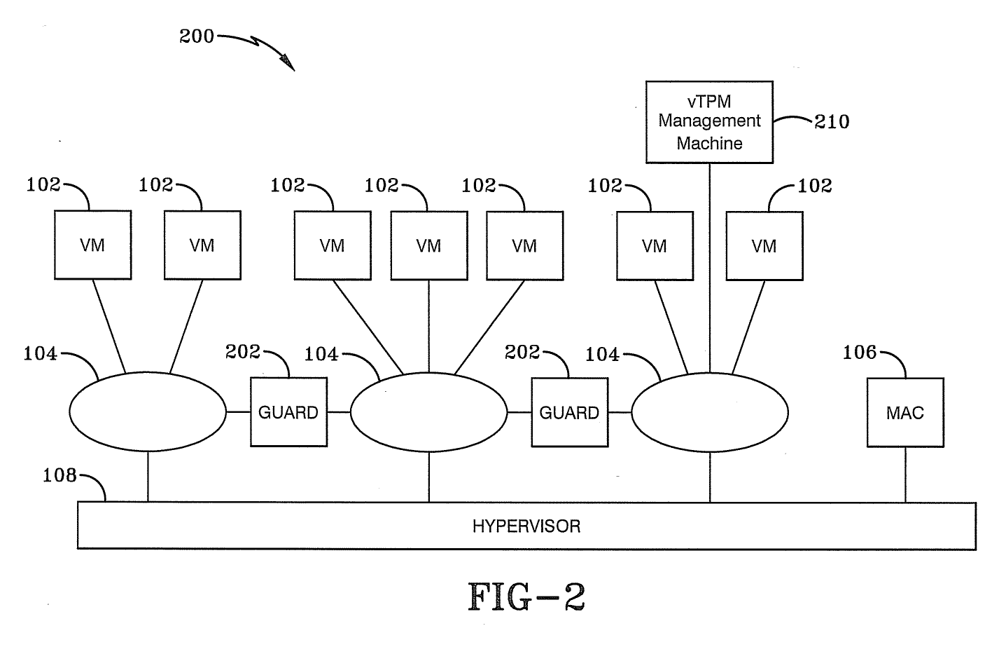

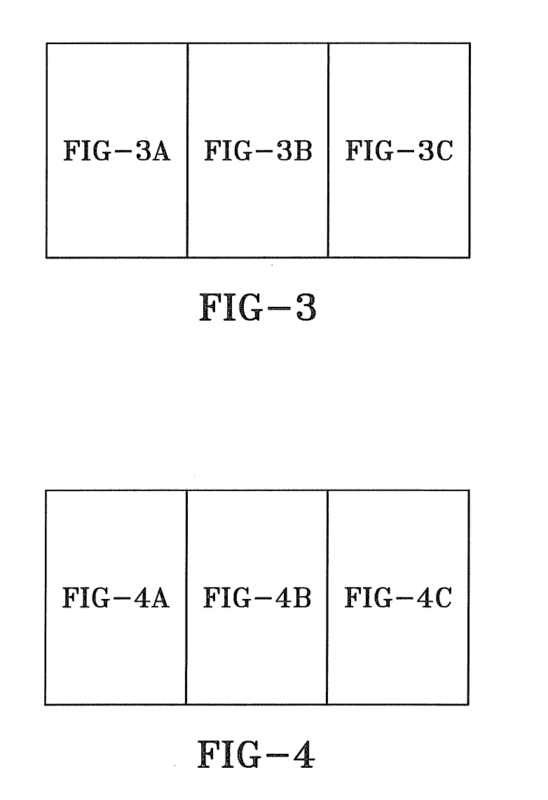

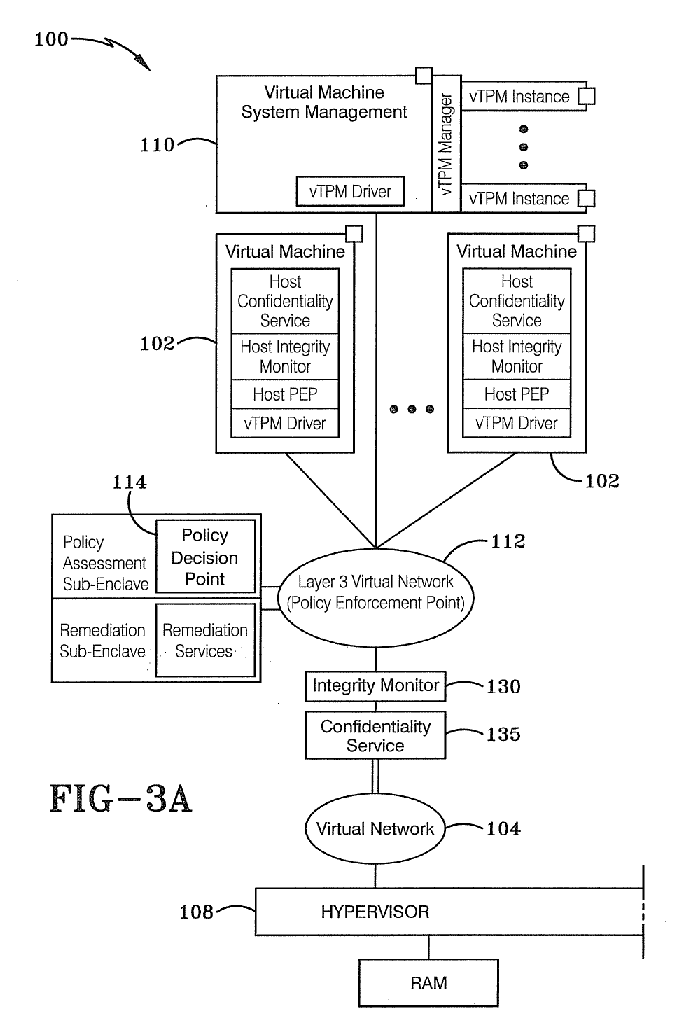

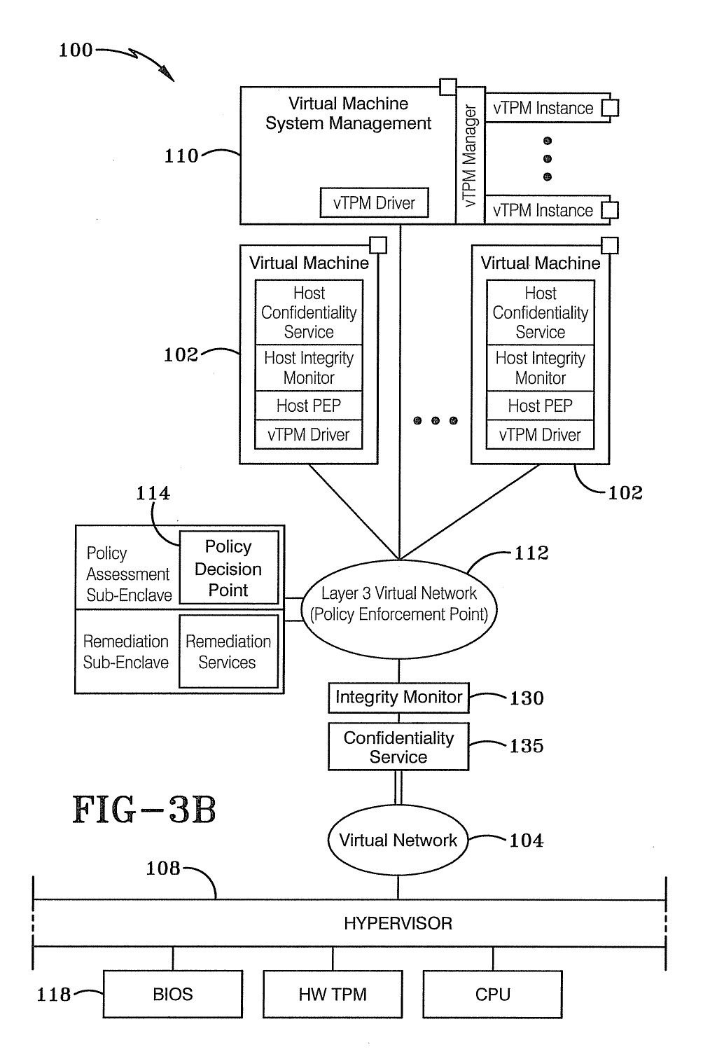

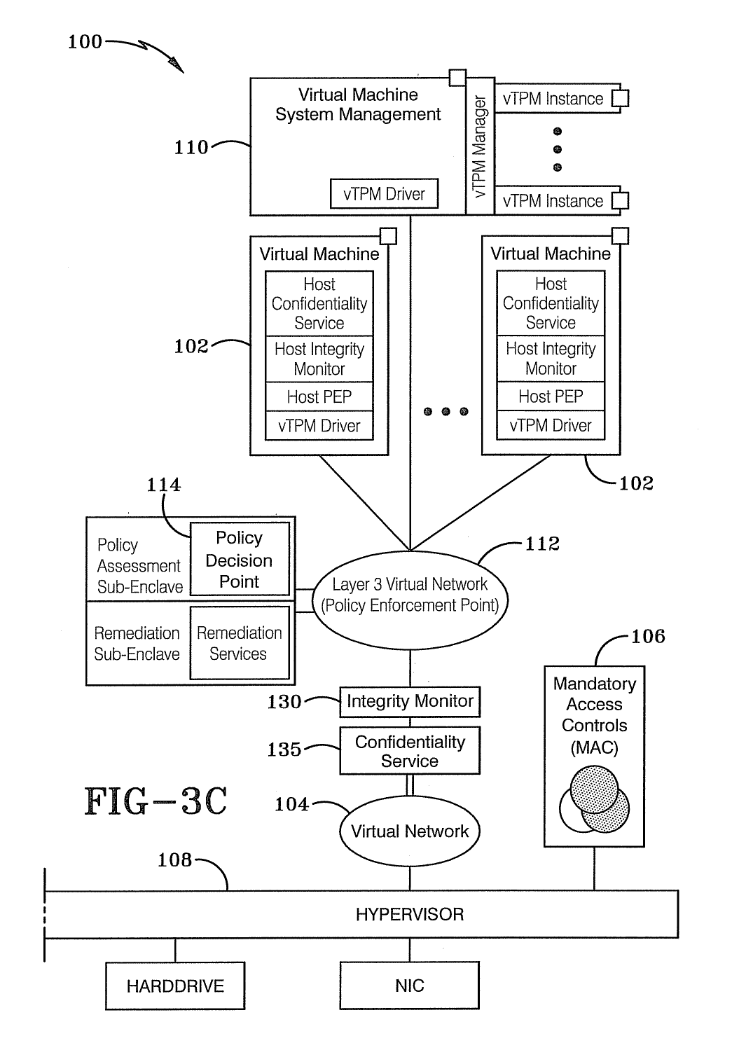

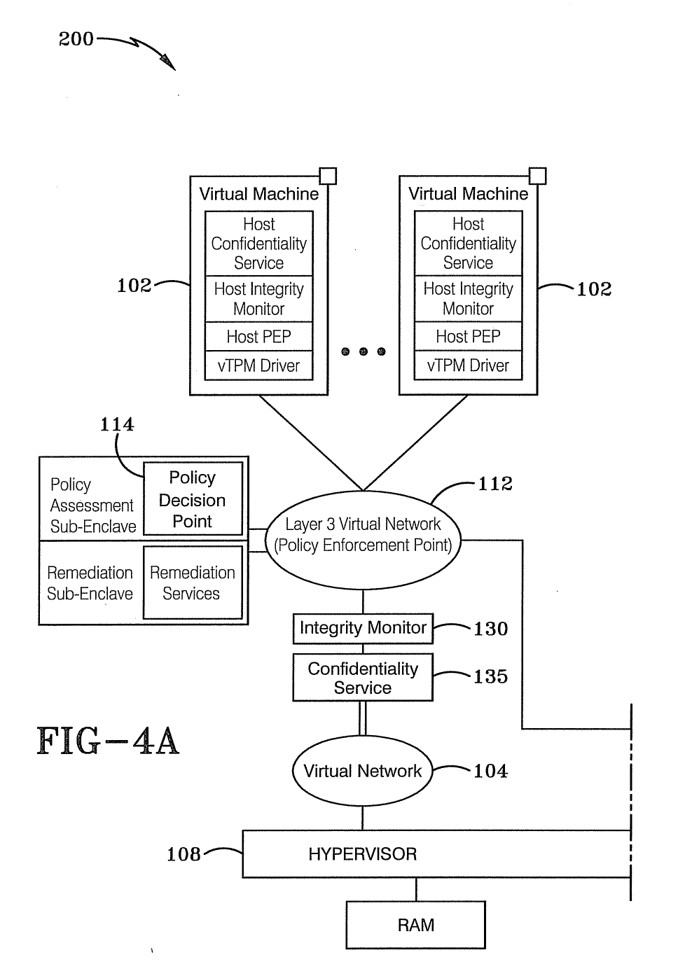

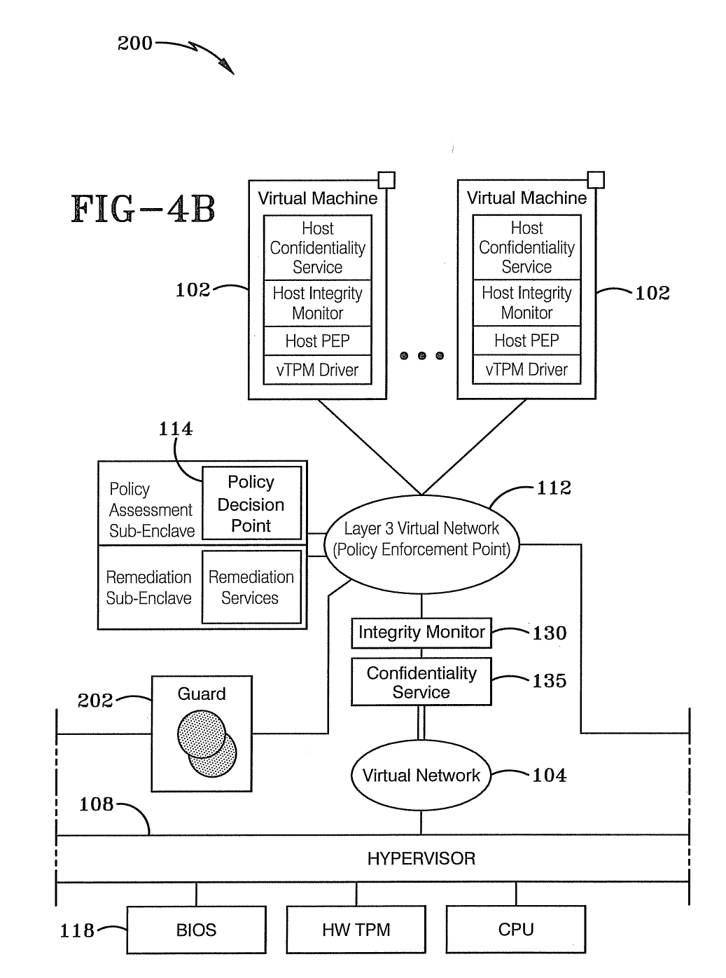

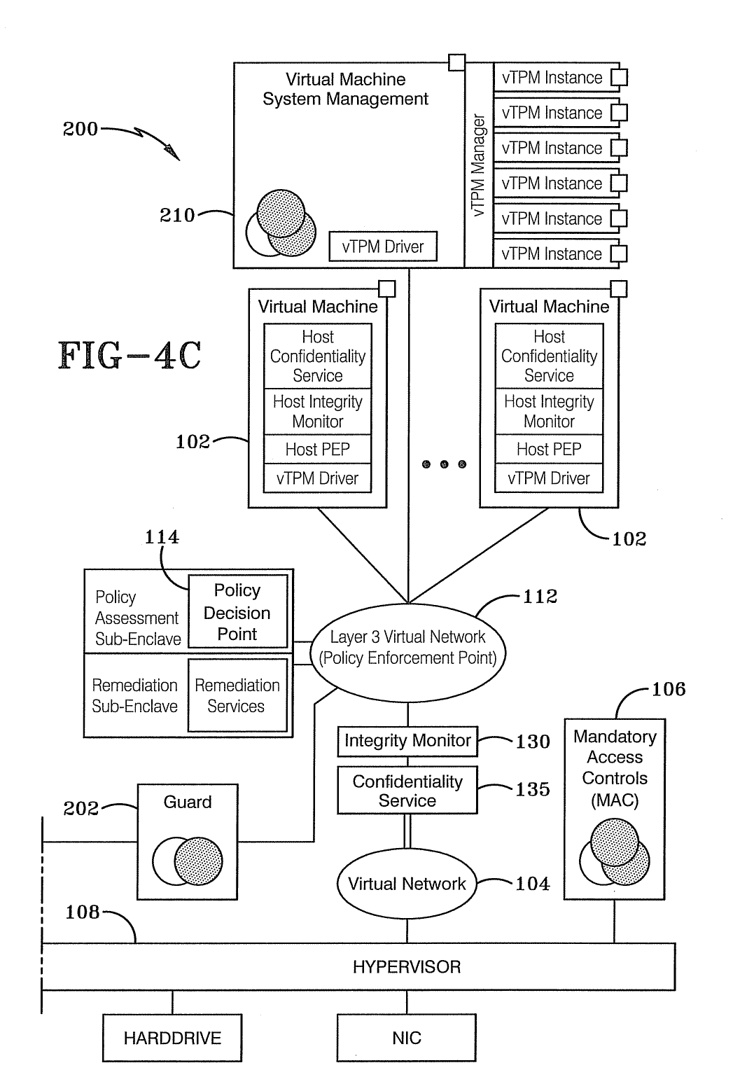

A first embodiment of a multilevel security (MLS) server framework is illustrated in FIGS. 1 and 3. A second and preferred embodiment of the MLS server framework is illustrated in FIGS. 2 and 4. FIGS. 1 and 2 illustrate the general structure of the first and second embodiments of the MLS server framework and are first discussed. FIGS. 3 and 4 illustrate additional details of the first and second embodiments and are discussed in greater detail below. Both the first and second embodiment of the MLS server framework provide a trusted virtual environment to host at least one of the groups of: multiple tenants, categories, classification enclaves and security enclaves.

The first embodiment of the MLS server framework 100 illustrated in FIG. 1 contains two or more virtual machines 102 connected to two or more networks 104. The networks 104 can be local area networks or another kind of network. The networks, 104 are connected to a hypervisor 108 that enforces the security policies and classifies virtual components within a trusted virtual environment formed by the MLS server framework 100. A mandatory access control (MAC) 106 that sets security policies is connected to the hypervisor 108. The first embodiment of the MLS server framework 100 is implemented with two or more virtual trusted platform module (vTPM) management machines 110 to provide attestation of each virtual machine to ensure the MLS server framework is in a secure state. In general, each secure enclave of the MLS framework will be monitored by its own vTPM management machine 110. The vTPM management machines 110 as well as other features of the MLS server framework 100, are discussed in greater detail below with reference to FIGS. 3 and 4.

FIG. 2 illustrates a second and preferred embodiment of a MLS server framework 200. Similar to FIG. 1, this embodiment includes virtual machines 102, virtual networks 104, a MAC 106, a hypervisor 108 but only a single vTPM management machine 210. The preferred embodiment of a MLS server framework 200 includes one or more virtual guard components 202. The guard components provide for the transfer of data between two different security enclaves. Unlike the first embodiment of the MLS server framework 100, the virtual guard components 202 allow a single vTPM management machine 210 to centrally manage the MLS server framework through the virtual guard components 202.

As shown in greater detail in FIGS. 3 and 4, the virtual machines 102 of first embodiment and the preferred embodiment may contain confidentiality services that provide data-at-rest and data-in-transit protection of the disclosure of confidential data. These virtual machines 102 contain host-based intrusion detection/prevention systems that monitor the integrity of the virtual machine and protect the network by preventing a connection by a machine which fails network access control (NAC) policy. Host policy enforcement points (PEP) 112 are deployed for use within an IPsec enabled NAC environment. The PEP 112 determines if the Virtual Machine is able to communicate with approved resources within the virtual environment based on system health status. Virtual Machines interact with the vTPM management virtual machine 110, 210 at system boot-up to validate the OS and application level integrity. The vTPM management 110, 210 provides attestation of each virtual machine to ensure that the system 100, 200 is in a secure state.

Virtual networks 102 provide switching and routing capabilities within the virtual environment to allow for the utilization of standard enterprise-level networking design patterns within the virtual environment. The networks 104 may contain integrity monitor logic 130 and/or confidentially service logic 135, one or more of the virtual machines 102 and one or more of the virtual networks 104. The integrity monitor logic 130 conducts deep packet inspection of ingress and egress data-in-transit from each security domain. The confidentiality service logic 135 provides encryption of the data-in-transit to protect the data-in-transit over a shared hardware platform with the MLS server framework 100. NAC-enabled virtual switches which use 802.1x port authentication act as policy enforcement points regulating how virtual machines 102 can communicate within the virtual network 104 based on system health status. Remediation services patch systems that are non-compliant with the system health standards before allowing them access to the operational network. A Policy Decision Point (PDP) 114 validates the health status of the virtual machines 102 requesting permission to access the virtual network 104. In one configuration of the preferred embodiment, each virtual machine 102 should meet the health standards set by the PDP 114 to access the operational virtual network 104, otherwise they are sent to remediation. CDS transfer solutions can operate within the virtual network and provide cross domain communications between different classification virtual machines.

By leveraging trusted operating systems, the hypervisor 108 is able to use the MAC 106 to assign classification levels to virtual machines 104, virtual network devices, and virtual drivers. A basic input/output system 118 BIOS, Hypervisor 108, and vTPM Manager 110, 210 interact with a hardware-based TPM solution to verify that no modifications or configuration changes have occurred since the trusted secure build of the system was performed.

The vTPM 110, 210 manages the state of virtual machine operating systems and applications, extending the hardware TPM capability to the virtual machines 102. The vTPM management machines 110, 210 are part of an MLS aware system management interface that communicates securely through the transfer guard 202 solutions. This secure communication provides the ability to receive Simple Network Management Protocol (SNMP) data from devices within the entire virtual environment to a consolidated network management interface within the system-high domain. This consolidated management approach provides significant reduction in equipment and licenses required for enterprise system management and also provides a complete enterprise view of all resources across multiple security domains.

The HAP server applicability and allocation across reference model components for information security sub-categories are described in Table 1:

TABLE 1
High Access Platform (HAP) HAP Server Information Security
Foundations

| | | TRM |
|---|---|---|
| Sub Capacity | HAP Server Applicability | Allocation |
| Input/Output Device | Association of classification level with system drivers and I/O | MAC |
| Protection | resources within the TRM MAC mechanism provides MAC | |
| | level access control. | |
| Mutual Attestation | Mutual attestation is essential within a HAP server | Virtual Machine, |
| | environment in order to leverage virtual migration capabilities | vTPM Manager, |
| | found within enterprise level virtualization solutions. The | HW TPM, |
| | ability for a virtual machine to move from one hardware | Hypervisor |
| | platform to another without compromising its integrity | |
| | leverages both hardware and virtual TPM solutions. vTPM is | |
| | a still somewhat immature capability and our team is working | |
| | within the TCG to develop a standard that allows virtual | |
| | machines migration utilizing vTPM design patterns. | |
| Phased Integrity | Leverages hardware-based TPM solutions to measure the | HW TPM, BIOS, |
| Measurements | BIOS and Hypervisor integrity against a secure state. | Hypervisor, vTPM |
| | Further extending those measurements via a vTPM | Manager, Virtual |
| | management machine that is attested directly with the | Machine, Integrity |
| | hardware TPM but contains secure states for Virtual | Monitor |
| | Machines (VM) and applications running within the VMs. | |
| | Finally, running integrity monitoring services within both the | |
| | VMs and the virtual network to detect/prevent system | |
| | changes to the VMs. | |
| Integrity-Based | Incorporating hardware-based TPM within the TRM allows for | HW TPM, |
| Platform Policy | the capture of a secure state of the hypervisor, BIOS, MAC, | Hypervisor, BIOS, |
| Enforcement | and vTPM manager components. The hardware TPM | MAC, vTPM |
| | provides integrity checks throughout the life of the system to | Manager, Virtual |
| | guarantee that components do not deviate from the secure | Machine |
| | build. Due to storage limitations within hardware-based TPM, | |
| | the TRM further extends attestation via the vTPM manager | |
| | which validates the integrity of virtual machines operating | |
| | systems and applications. | |
| Data at Rest | Host confidentiality service running within each virtual | Virtual Machine |
| Protection | machine provides data-at-rest encryption leveraging NSA | |
| | Suite B standards to protect confidentiality of Unclassified, | |
| | Secret, and Top Secret data utilizing software-based | |
| | cryptographic solutions. | |
| Data in Transit | Reference model leverages virtual IPsec Gateway solution to | Confidentiality |
| Protection | provide NSA Suite B encryption of data-in-transit. Meeting | Service, NIC |
| | the Suite B standards allows for software-based commercial | |
| | encryption solutions to protect Unclassified, Classified, and | |
| | Top Secret data in transit. Maintaining separation via Suite B | |
| | encryption vs. physical separation allows for the TRM to | |
| | collapse the physical Network Interface Cards (NIC) on the | |
| | hardware platform to a single interface card. | |
| Data in Memory | The MAC component within the TRM provides partitioning of | MAC, RAM, Hard |
| Protection | DRAM to specific security domain and meets the separation | drive |
| | kernel and multi-level OS Protection Profiles to ensure that | |
| | proper isolation is maintained. | |
| Secure Disposal | The TRM has the ability to host confidentiality services that | MAC, Virtual |
| | can provide secure disposal and data recovery. | Machine |
| Trusted Path | The TRM is focused on a server deployment but has a | Confidentiality |
| | confidentiality service that clients can authenticate and | Service, Layer 3 |
| | establish IPsec sessions for access to the server virtual | Virtual Network |
| | machines. Also providing Network Access Controls within | PEP, PDP, Virtual |
| | the virtual network clients accessing the virtual machines are | Machine |
| | required to present health status information of the systems | |
| | prior to obtaining access to virtual machines. | |
| Trusted Display | Within the TRM the MAC component extends its labeling | MAC, Hypervisor |
| | mechanisms to the hypervisor and the hypervisor become | |
| | MLS aware. Components within the virtual environment are | |
| | labeled with classification levels. | |
| Network Event | Virtual Machine System Management capability supports | Virtual Machine |
| Analysis | Event Management, including event normalization, event de- | System |
| | duplication and event correlation. Sources for event | Management, |
| | information can be collected and coordinated using tools | Guard |
| | from the consortium members, and from other parties. The | |
| | correlation can also be performed at a system high level, | |
| | using the passing of event information through the Guards. | |

The HAP server applicability and allocation across reference model component for information sharing subcategories are described in Table 2:

TABLE 2
HAP Server Information Sharing

| Sub-Capability | HAP Server Applicability | TRM Allocation |
|---|---|---|
| Single Sign On | The TRM has the ability to host Single Sign On (SSO) | Virtual Machine |
| | services within the virtual machine components. | |
| Multi-Factor | The TRM can host domain specific credential solutions within | Virtual Machine |
| Authentication/Multi- | virtual machines to support multi-factor authentication within | |
| Level Token | each security domain. Virtual Machines within the TRM can | |
| | leverage PKI solutions to provide two-factor authentication | |
| | for users accessing the system (smart card and user | |
| | ID/password). | |
| Cross Domain | Incorporation of CDS Transfer solutions (virtual guard) into | Guard, Layer 3 |
| Sharing | the reference model to allow for information sharing across | Virtual Network |
| | various virtual network environments. | PEP |
| Cross Domain | Incorporation of CDS Transfer solutions (virtual guard) into | Guard, Layer 3 |
| Discovery | the reference model to allows for information discovery across | Virtual Network |
| | various virtual network environments. | PEP |
| Cross Domain | Incorporation of CDS Transfer solutions (virtual guard) into | Guard, Layer 3 |
| Collaboration | the reference model to allows for collaboration across various | Virtual Network |
| | virtual network environments. | PEP |
| Communities of | The MAC component within the TRM can create new | MAC, Hypervisor |
| Interest (COI) | Communities of Interest (COI) based on defined security | |
| | policies that are applied to the system. Once a policy is | |
| | applied, the MAC can assign components within the TRM to | |
| | that COI. A server environment can consist of pre-deployed | |
| | virtual networks and machines that are not associated with a | |
| | classification level and once a policy is deployed and | |
| | immediately inherent that COI. | |
| Trusted Service | By collecting the requirements necessary for interfacing to | N/A |
| Interface | HAP platform services our team can validate that components | |
| | within the TRM properly address HAP standards. Our team is | |
| | prepared work with the NSA HAP Program Office to extend | |
| | the TRM to support advancements within HAP platform level | |
| | services to address outside service calls. | |
| General User Access | Within the TRM MAC component users and services are | MAC |
| | assigned clearances while data within the system is | |
| | associated with classification levels to provide strict access | |
| | controls that meet DoD (MAC I) and Intelligence Community | |
| | (PL 5) policies. | |

The HAP server applicability and allocation across reference model component for manageability/infrastructure subcategories are described in Table 3:

TABLE 3
Manageability/Infrastructure-Managing HAP Server

| Sub-Capability | HAP Server Applicability | TRM Allocation |
|---|---|---|
| Single Wire | Utilizing IPsec with Suite B within the TRM confidentiality | Confidentiality |
| | component to protect Unclassified, Secret, and Top Secret | Service, NIC |
| | data on a single wire. | |
| Remote Administration | Our team is prepared to work with the NSA HAP Program | N/A |
| | Office to extend services within the TRM to support Remote | |
| | Administration. | |
| Lightweight | The TRM is currently modeled after a server side. | N/A |
| Operations | | |
| Interoperability | The TRM is currently focused on a server side deployment | N/A |
| | but may include the ability to host server side applications | |
| | that interface with HAP client-based solutions to provide | |
| | interoperability. | |
| Peer-to-peer | The TRM is currently focused on a server side deployment | N/A |
| Communications | but may include the NSA HAP Program Office the ability for | |
| | the TRM to address peer-to-peer communications. | |

The HAP server form factor option subcategories are described in Table 4:

TABLE 4
HAP Server Form Factor Options

| Sub-Capability | HAP Server Applicability | TRM Allocation |
|---|---|---|
| Laptop | While not specifically focused on a client based solution, the | Interoperable via |
| | MLS Server ability to interact with Laptops over standard | IP interface |
| | TCP/IP. | |
| Workstation | While not specifically focused on a client based solution, the | Interoperable via |
| | MLS Server ability to interact with Workstations over standard | IP interface |
| | TCP/IP. | |
| Server | The TRM is a design pattern that applies across various | HW TPM, NIC, |
| | hardware platforms but is geared towards a server side | CPU, RAM |
| | deployment. The hardware based TPM is a hardware solution | |
| | that server hardware must support to provide proper security | |
| | controls. | |
| Embedded System | While not specifically focused on a client based solution, the | Interoperable via |
| | MLS Server ability to interact with Embedded Systems over | IP interface |
| | standard TCP/IP. | |
| Handheld Devices | While not specifically focused on a client based solution, the | Interoperable via |
| | MLS Server ability to interact with Handheld Devices over | IP interface |
| | standard TCP/IP. | |

In the foregoing description, certain terms have been used for brevity, clearness, and understanding. No unnecessary limitations are to be implied therefrom beyond the requirement of the prior art because such terms are used for descriptive purposes and are intended to be broadly construed. Therefore, the invention is not limited to the specific details, the representative embodiments, and illustrative examples shown and described. Thus, this application is intended to embrace alterations, modifications, and variations that fall within the scope of the appended claims.

Moreover, the description and illustration of the invention is an example and the invention is not limited to the exact details shown or described. References to “the preferred embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in the preferred embodiment” does not necessarily refer to the same embodiment, though it may.

What is claimed is:

1. A multilevel security (MLS) server framework to provide a trusted virtual environment to host at least one of the groups of: multiple tenants, categories, classification enclaves and security enclaves, comprising:
a plurality of virtual machines;
a plurality of virtual local area networks (LANs) connected to the virtual machines;
a mandatory access control (MAC) to set security policies;
a hypervisor connected to the MAC and the virtual LANs to enforce the security policies and to classify virtual components within a trusted virtual environment formed by the MLS server framework; and
a virtual trusted platform module (vTPM) management machine to provide attestation of each virtual machine to ensure the MLS server framework is in a secure state.

2. The MLS server framework of claim 1 wherein the MLS server framework is formed with a plurality of security domains and further comprising:
an integrity monitor connected between one of the virtual machines and one of the virtual LANs to conduct deep packet inspection of ingress and egress data-in-transit from each security domain.

3. The MLS server framework of claim 1 further comprising:
confidentiality service logic between one of the virtual machines and one of the virtual LANs to provide encryption of the data-in-transit to protect the data-in-transit over a shared hardware platform with the MLS server framework.

4. The MLS server framework of claim 1 further comprising:
policy enforcement points (PEPs) deployed within the network to determine based, at least in part, on a system status of the MLS server framework if at least one of the virtual machines is classified to communicate with an approved resource within MLS server framework.

5. The MLS server framework of claim 1 further comprising:
a plurality of virtual network switches to provide port authentication and networking to enforce policy and attest the virtual machines to the virtual LANs.

6. The MLS server framework of claim 1 further comprising:
a virtual trusted platform module (vTPM) to manage the state of an operating system associated with at least one of the plurality of virtual machines.

7. The MLS server framework of claim 1 wherein the virtual network switch is a layer 3 networking switch that acts as a policy enforcement point (PEP) and directly communicates with one or more of the virtual machines.

8. The MLS server framework of claim 7 wherein the PEP validates the health status of a virtual machine requesting permission to access one of the virtual LANs.

9. The MLS server framework of claim 1 further comprising:
a virtual trusted platform module (vTPM) management machine;
a basic input/output system (BIOS); and
a hardware based trusted platform module (TPM), wherein the BIOS and vTPM management machine interact with the hardware based TPM to ensure that no configuration changes have occurred since a trusted build of the MLS server framework was performed.

10. The MLS server framework of claim 9 further wherein the hardware based TPM and the BOIS are connected to the hypervisor.

11. The MLS server framework of claim 1 further comprising:
at least one of the group of: random access memory connected to the hypervisor, a central processing unit (CPU) connected to the hypervisor, a hard drive connected to the hypervisor and a network interface card connected to the hypervisor.

12. The MLS server framework of claim 1 further comprising:
at least one virtual guard component to provide for cross domain transfer of data between different security enclaves.

13. The MLS server framework of claim 1 wherein the mandatory access controller (MAC) is connected to the hypervisor.

14. The MLS server framework of claim 1 wherein at least one of the virtual networks acts as a policy enforcement point (PEP) and communicates directly with one of the virtual machines acting as a policy decision point (PDP).

15. The MLS server framework of claim 1 wherein upon boot up at least one of the virtual machines is configured to validate an operating system (OS) and application level integrity.

16. A multilevel security (MLS) server framework comprising:
a plurality of virtual machines;
a plurality of virtual networks, wherein one or more of the virtual machines are connected to one or more of the virtual networks;
a mandatory access control (MAC) to set security policies;
a hypervisor connected to the MAC to enforce the security policies;
a virtual trusted platform module (vTPM) management machine, wherein the plurality of virtual networks and plurality of virtual machines form a virtual environment with different security enclaves; and
one or more virtual guard components to provide for the transfer of data between two different security enclaves, wherein the vTPM management machine centrally manages the MLS server framework through the one or more virtual guard components.

17. The MLS server framework of claim 16 wherein the each of the virtual machines further comprise:
A host-based intrusion detection/prevention system that monitors the integrity of a corresponding virtual machine and protects the virtual environment by preventing a connection by a virtual machine with that fails a network access control (NAC) policy check by the intrusion detection/prevention system.

18. The MLS server framework of claim 16 wherein the vTPM management machine is configured to validate an operating system (OS) integrity of one or more of the virtual machines when the one or more of the virtual machines is booted up.

19. The MLS server framework of claim 16 further comprising:
a policy decision point (PDP) to determine if a health value of a virtual machine requesting access to one of the virtual networks has reached a first health threshold, and sending the virtual machine requesting access to one of the virtual networks to remediation when the health value has not reached the first health threshold.

20. The MLS server framework of claim 16 further comprising:
a plurality of virtual network switches to provide port authentication and networking to enforce policy and attest the virtual machines to the virtual networks.

21. The MLS server framework of claim 16 further comprising:
a basic input/output system (BIOS); and
a hardware based trusted platform module (TPM), wherein the BIOS and vTPM management machine interact with the hardware based TPM to ensure that no configuration changes have occurred since a trusted build of the MLS server framework was performed.
